(19) United States
(12) Patent Application Publication
(10) Pub. No.: US 2026/0260955 A1
(43) Pub. Date: Sep. 3, 2026

(54) BATTERY PACK STRUCTURE AND ELECTRIC TOOL

(71) Applicant: Zhejiang Kaichuang Electric Co., Ltd., Jinhua (CN)

(72) Inventors: Feng DING, Jinhua (CN); Gaochun ZHANG, Jinhua (CN)

(73) Assignee: Zhejiang Kaichuang Electric Co., Ltd., Jinhua (CN)

(21) Appl. No.: 19/540,799

(22) Filed: Feb. 16, 2026

(30) Foreign Application Priority Data
Feb. 28, 2025 (CN) 202510235079.4

(51) Int. Cl. H01M 10/42; H01M 50/103; H01M 50/209; H01M 50/213; H01M 50/244

(52) U.S. Cl. CPC H01M 10/425; H01M 50/103; H01M 50/209; H01M 50/213; H01M 50/244

(57) ABSTRACT

A battery pack structure and an electric tool are provided. The battery pack structure includes a housing assembly and a battery cell integrated structure; the housing assembly includes a shell, and a first avoidance port is provided at the bottom of the shell; the battery cell integrated structure is arranged inside the shell and includes a battery cell and a first connection end electrically connected to the battery cell; the first connection end can be electrically connected to an electric tool body through the first avoidance port along an axial direction of the shell, so that the battery cell can supply power to the electric tool body; an outer wall of the shell that is in contact with the electric tool body is provided with a guide track, which is slidably connected to the electric tool body, a sliding direction being the axial direction of the shell.

### CROSS REFERENCE TO THE RELATED APPLICATIONS

This application is based upon and claims priority to Chinese Patent Application No. 202510235079.4, filed on February 28, 2025, the entire contents of which are incorporated herein by reference.

### TECHNICAL FIELD

The present disclosure belongs to the technical field of electric tools, and specifically relates to a battery pack structure and an electric tool.

### BACKGROUND

In order to improve the versatility of electric tools so that the working ranges thereof are not limited by the positions of sockets, many electric tools on the market use battery packs for power supply. The battery packs have the advantages such as convenient portability and simple installation, which can greatly expand the application range of electric tools.

Existing battery pack structures are usually equipped with multiple battery cells, making the battery pack structures bulky and occupy a large volume. When used for miniaturized electric tools, due to the lack of a miniaturized battery pack structure, existing miniaturized electric tools usually have the battery pack fixed inside them, making it inconvenient to replace the battery cells and making the sustainability of electric tools not strong, which results in inconvenient use.

Therefore, it is urgent to propose a battery pack structure which has a compact structure and is convenient to install to adapt to the miniaturization development of electric tools.

### SUMMARY

An object of the present disclosure is to provide a battery pack structure which has a compact structure and is convenient to install. This object is achieved through the following technical solutions.

A first aspect of the present disclosure proposes a battery pack structure, which includes a housing assembly and a battery cell integrated structure; the housing assembly includes a shell, and a first avoidance port is provided at the bottom of the shell; the battery cell integrated structure is arranged inside the shell, and the battery cell integrated structure includes a battery cell and a first connection end electrically connected to the battery cell; the first connection end can be electrically connected to an electric tool body through the first avoidance port along an axial direction of the shell, so that the battery cell can supply power to the electric tool body; an outer wall of the shell that is in contact with the electric tool body is provided with a guide track, which is slidably connected to the electric tool body, with a sliding direction being the axial direction of the shell.

By utilizing the battery pack structure provided by this technical solution, during the installation process of the battery pack structure and the electric tool body, the first connection end can be connected to an electricity-powered connector of the electric tool body along the axial direction of the shell. At the same time, the sliding connection between the guide track and the electric tool body limits the movement path of the battery pack structure, ensuring that the first connection end can be accurately inserted into a designated position without error. By adopting this structural design, the assembly and disassembly process between the battery pack structure and the electric tool body becomes extremely convenient and efficient.

In addition, the battery pack structure of the present disclosure may also have the following additional technical features.

In some embodiments of the present disclosure, the guide track is a guide groove arranged axially along the outer wall of the shell.

In some embodiments of the present disclosure, the guide groove includes a first section and a second section; a first end of the first section has an insertion port facing the bottom of the shell; a second end of the first section is communicated with the second section, and a width of the first section gradually decreases from the first end to the second end.

In some embodiments of the present disclosure, the guide groove further includes a third section communicated with the second section and a fourth section communicated with the third section, where the third section and the second section are arranged at an angle, and the fourth section is perpendicular to the third section.

In some embodiments of the present disclosure, the guide track is a protrusion arranged axially along the outer wall of the shell, or the guide track is a magnetic attraction structure.

In some embodiments of the present disclosure, the battery cell integrated structure further includes a second connection end electrically connected to the battery cell, and a second avoidance port is provided at the bottom of the shell; the second connection end can be electrically connected to a power supply device through the second avoidance port to supply power to the battery cell.

In some embodiments of the present disclosure, the battery cell integrated structure further includes a control circuit board located between the battery cell and the bottom of the shell; the control circuit board includes a first circuit board and a second circuit board that are arranged along the axial direction of the shell, and the first circuit board is electrically connected to the second circuit board; the first circuit board is located on the side close to the battery cell, and the battery cell is electrically connected to the first connection end through the first circuit board.

In some embodiments of the present disclosure, the battery cell integrated structure includes a first conductive sheet, one end of which is electrically connected to an end of the battery cell that is away from the first circuit board, and the other end of which is electrically connected to the first circuit board; and a positioning groove is arranged axially along an inner wall of the shell for placing the first conductive sheet.

In some embodiments of the present disclosure, the housing assembly further includes a cover, and an insertion portion is provided at an opening of the cover; the top of the shell has an installation port, a snap-fit hole is provided in a circumferential direction of the insertion portion, and a protrusion is arranged on an inner side of the top of the shell; the insertion portion is inserted into the installation port, and the snap-fit hole is snap-fit with the protrusion.

A second aspect of the present disclosure proposes an electric tool, which includes an electric tool body and the battery pack structure as described in the above embodiments; the electric tool body has a battery compartment for installing the battery pack structure, and an inner wall of the battery compartment is provided with a connection port and a connection portion; the connection port is electrically connected to the first connection end, and the guide track and the connection portion are slidably connected.

### BRIEF DESCRIPTION OF THE DRAWINGS

Upon reading detailed description of the preferred embodiments below, various other advantages and benefits will become clear to those skilled in the art. The accompanying drawings are only used for the purpose of illustrating the preferred embodiments, and should not be considered as a limitation to the present disclosure. Moreover, throughout the drawings, the same reference signs are used to denote the same components. In the drawings:

FIG. 1 schematically shows a structural view of the battery pack structure according to an embodiment of the present disclosure;

FIG. 2 schematically shows an exploded view of the battery pack structure according to an embodiment of the present disclosure;

FIG. 3 schematically shows a structural view of the battery cell integrated structure according to an embodiment of the present disclosure;

FIG. 4 schematically shows an exploded view of the battery cell integrated structure according to an embodiment of the present disclosure;

FIG. 5 schematically shows a structural view of the shell according to an embodiment of the present disclosure;

FIG. 6 schematically shows a structural view of a cover according to an embodiment of the present disclosure; and

FIG. 7 schematically shows a structural view of another cover according to an embodiment of the present disclosure.

### LIST OF REFERENCE SIGNS

100: housing assembly; 110: shell; 111: guide track; 1111: first section; 1112: second section; 1113: third section; 1114: fourth section; 114: buckle; 115: positioning groove; 116: positioning protrusion; 117: anti-rotation portion; 120: cover; 121: insertion portion; 122: snap-fit hole; 123: notch; 124: handle;

200: battery cell integrated structure; 201: battery cell; 202: first connection end; 203: second connection end; 204: first circuit board; 204a: first positioning protrusion; 205: second circuit board; 206: first conductive sheet; 206a: first connection portion; 2061a: first sheet-like structure; 2062a: second sheet-like structure; 206b: conductive sheet body; 206c: second connection portion; 207: second conductive sheet; 207a: third sheet-like structure; 207b: fourth sheet-like structure; 207c: fifth sheet-like structure; 208: first gasket; 209: second gasket; 209a: second positioning protrusion; 209b: ring-like rib; 210: first connector; 211: second connector; 212: protective cover; 213: button; 214: indicator light; 215: heat dissipation pad.

### DETAILED DESCRIPTION OF THE EMBODIMENTS

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may be only used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will then be oriented “above the other elements or features” or “over the other elements or features”. Thus, the exemplary term “below” may include orientations of both above and below.

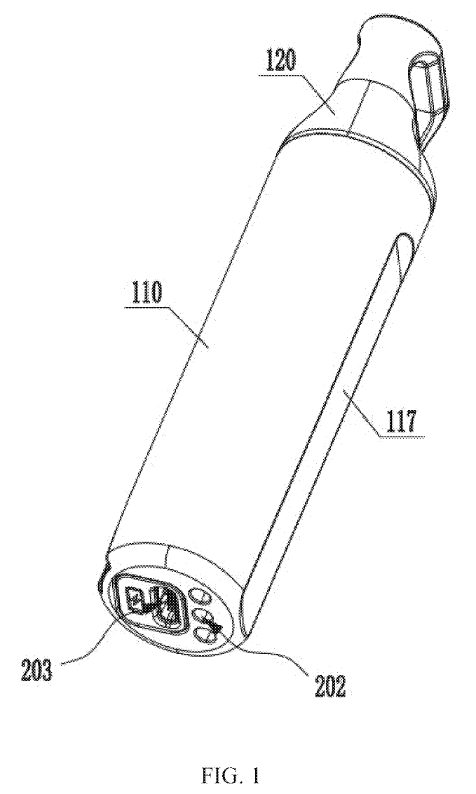

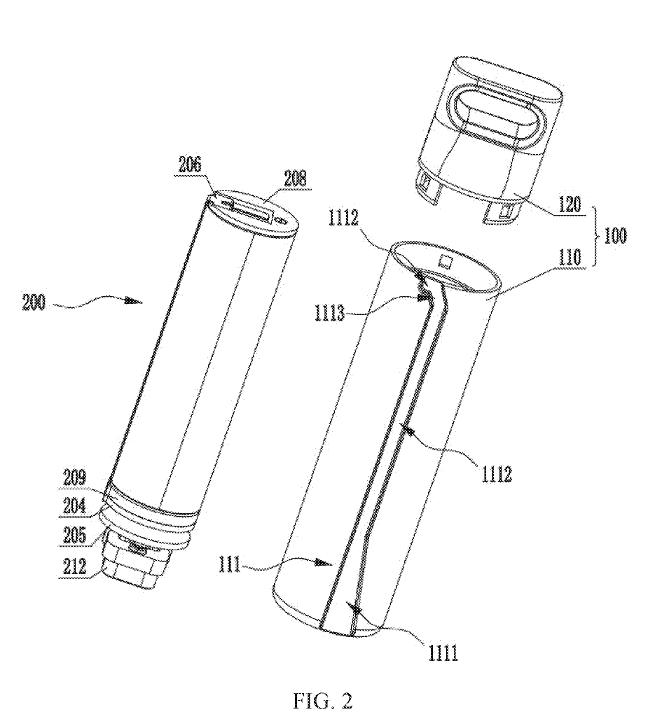

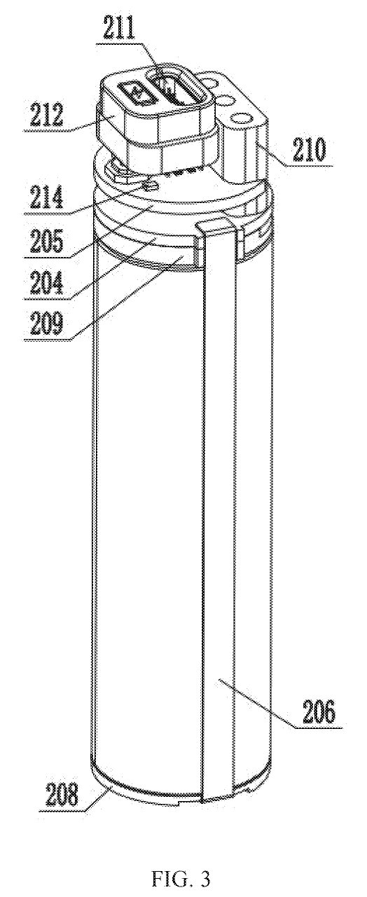

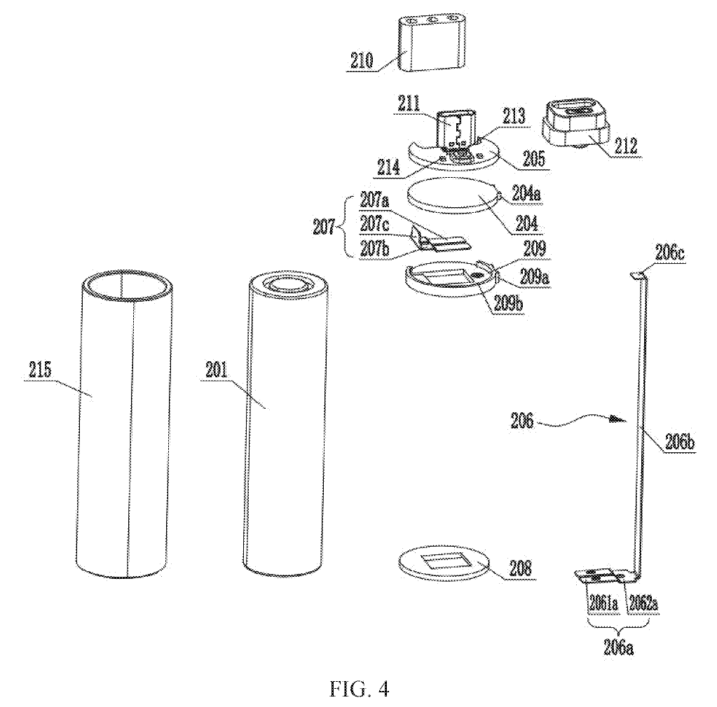

FIG. 1 schematically shows a structural view of the battery pack structure according to an embodiment of the present disclosure. FIG. 2 schematically shows an exploded view of the battery pack structure according to an embodiment of the present disclosure. FIG. 3 schematically shows a structural view of a battery cell integrated structure 200 according to an embodiment of the present disclosure. FIG. 4 schematically shows an exploded view of the battery cell integrated structure 200 according to an embodiment of the present disclosure. As shown in FIGS. 1-4, the present disclosure proposes a battery pack structure, which includes a housing assembly 100 and a battery cell integrated structure 200. The housing assembly 100 includes a shell 110, and a first avoidance port is provided at the bottom of the shell 110. The battery cell integrated structure 200 is arranged inside the shell 110, and the battery cell integrated structure 200 includes a battery cell 201 and a first connection end 202 electrically connected to the battery cell 201. The first connection end 202 can be electrically connected to an electric tool body along an axial direction of the shell 110 through the first avoidance port, so that the battery cell 201 can supply power to the electric tool body. An outer wall of the shell 110 that is in contact with the electric tool body is provided with a guide track 111, which is slidably connected to the electric tool body, with a sliding direction being the axial direction of the shell 110.

By utilizing the battery pack structure provided by this technical solution, during the installation process of the battery pack structure and the electric tool body, the first connection end 202 can be connected to an electricity-powered connector of the electric tool body along the axial direction of the shell 110. At the same time, the sliding connection between the guide track 111 and the electric tool body limits the movement path of the battery pack structure, ensuring that the first connection end 202 can be accurately inserted into a designated position without error. By adopting this structural design, the assembly and disassembly process between the battery pack structure and the electric tool body becomes extremely convenient and efficient.

Further, referring to FIGS. 1-2, the shell 110 has an approximately cylindrical shape, and the battery cell integrated structure 200 can be installed into the interior of the shell 110 along the axial direction of the shell 110. Optionally, the outer wall of the shell 110 is provided with an anti-rotation portion 117, which is located on the opposite side of the guide track 111. When the battery pack structure is placed on a flat surface, the anti-rotation portion 117 can prevent the battery pack structure from rolling. For example, the anti-rotation portion 117 can be a planar structure or bracket, etc. Optionally, the first connection end 202 can be a Type-C interface.

Further, referring to FIG. 2, the guide track 111 is a guide groove arranged axially along the outer wall of the shell 110.

Correspondingly, in order to ensure that the battery pack structure can be correctly and stably installed, an insertion protrusion is provided on the electric tool body. During the installation process of the battery pack structure, the user needs to align the guide groove with the insertion protrusion, and then push the battery pack structure along the extension direction of the guide groove until the first connection end 202 is successfully connected with the electricity-powered connector on the electric tool body through insertion. This insertion connection method implemented through the guide groove and the insertion protrusion not only effectively ensures that the connection end is installed in place, but also effectively prevents the battery pack structure from loosening after installation. It can be understood that since the insertion connection direction of the first connection end 202 and the electricity-powered connector on the electric tool body is along the axial direction of the shell 110, the guide groove should be designed to extend along the axial direction of the shell 110. In this way, when the guide groove moves along the insertion protrusion, the first connection end 202 can be smoothly connected to the electricity-powered connector. In addition, there are various design options for the insertion protrusion, such as rectangular insertion protrusion, square insertion protrusion, or cylindrical insertion protrusion, etc. The key is that they must be able to smoothly connect with the guide groove in a slidable manner.

Further, in some embodiments, the guide groove includes a first section 1111 and a second section 1112; a first end of the first section 1111 has an insertion port facing the bottom of the shell 110; a second end of the first section 1111 is communicated with the second section 1112, and a width of the first section 1111 gradually decreases from the first end to the second end.

By setting the first section 1111 to have this structural form, it is easy to connect the insertion port with the insertion protrusion by insertion. Optionally, the width of the second section 1112 is equal to the width of the insertion protrusion. Optionally, the lengths of the first section 1111 and the second section 1112 can be set as required for use respectively, and are not specifically limited herein.

Further, the guide groove also includes a third section 1113 communicated with the second section 1112 and a fourth section 1114 communicated with the third section 1113, where the third section 1113 and the second section 1112 are arranged at an angle, and the fourth section 1114 is perpendicular to the third section 1113.

It can be understood that by setting the guide groove into a fold line shape, the fourth section 1114 limits the axial displacement of the shell 110, which can prevent the first connection end 202 and the electricity-powered connector from loosening and prevent the first connection end 202 from falling off the electricity-powered connector. By using the third section 1113 to transition between the second section 1112 and the fourth section 1114, the sliding process of the shell 110 can be made smoother. Optionally, the angle between the extension direction of the third section 1113 and the extension direction of the second section 1112 can be 45° to 60°. For example, the angle can be 45°, 50°, 55°, or 60°, etc.

In some embodiments, the guide groove can also be linear. The position of the guide groove is set according to the positions of the first connection end 202 and the electricity-powered connector, thus ensuring that the first connection end 202 can be inserted in place.

Further, the guide track 111 is a protrusion arranged axially along the outer wall of the shell 110, or the guide track 111 is a magnetic attraction structure.

When the guide track 111 is a protrusion, correspondingly, a groove is provided on the electric tool body. When installing the battery pack structure, the protrusion is aligned with the groove, and the battery pack structure is pushed along the axial direction of the shell 110 so that the first connection end 202 and the electricity-powered connector are connected by insertion. Optionally, the magnetic attraction structure can be a magnet connected to the outer wall of the shell 110. Of course, the magnetic attraction structure can also be arranged inside the shell 110 or embedded in the wall of the shell 110, as long as it can be adsorbed to the electric tool body. When the guide track 111 is a magnetic attraction structure, correspondingly, materials such as iron or nickel that can be attracted by the magnet are provided on the electric tool body. When the battery pack structure is installed in place, the battery pack structure is adsorbed onto the electric tool body, thereby preventing the battery pack structure from rotating.

Further, referring to FIG. 1, the battery cell integrated structure 200 further includes a second connection end 203 electrically connected to the battery cell 201, and a second avoidance port is provided at the bottom of the shell 110; the second connection end 203 can be electrically connected to a power supply device through the second avoidance port to supply power to the battery cell 201.

In some cases, the second connection end 203 can be selectively designed as a Type-C interface, and the advantage of this design is that it can be adapted to the connector of Type-C interface, thus providing a more convenient configuration. In this way, when it is required to charge the devices, it is less likely for users to fail to charge them due to the inability to find compatible power supply connectors.

Further, referring to FIGS. 3-4, the battery cell integrated structure 200 further includes a control circuit board located between the battery cell 201 and the bottom of the shell 110; the control circuit board includes a first circuit board 204 and a second circuit board 205 that are arranged along the axial direction of the shell 110, and the first circuit board 204 is electrically connected to the second circuit board 205; the first circuit board 204 is located on the side close to the battery cell 201, and the battery cell 201 is electrically connected to the first connection end 202 through the first circuit board 204.

By using multiple circuit boards that are arranged in layers, the internal space of the shell 110 can be reasonably utilized. In this embodiment, the control circuit board includes two circuit boards. In other embodiments, the control circuit board may also include three or more circuit boards. Optionally, a negative electrode of the battery cell 201 is inserted into the shell 110 toward the bottom of the shell 110, with the control circuit board located between the negative electrode of the battery cell 201 and a bottom plate of the shell 110.

Optionally, a first connector 210 is provided at the first connection end 202, and an avoidance port is provided on the second circuit board 205. The first connector 210 is located at the avoidance port, and an end thereof is fixed to the first circuit board 204. Optionally, a second connector 211 is provided at the second connection end 203, and the second connector 211 is connected to the second circuit board 205.

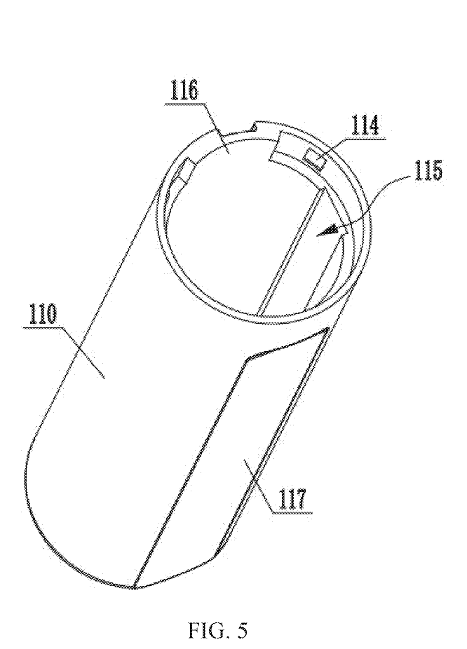

Further, FIG. 5 schematically shows a structural view of the shell 110 according to an embodiment of the present disclosure. Referring to FIGS. 4-5, the battery cell integrated structure 200 includes a first conductive sheet 206. One end of the first conductive sheet 206 is electrically connected to an end of the battery cell 201 that is away from the first circuit board 204, and the other end of the first conductive sheet 206 is electrically connected to the first circuit board 204. A positioning groove 115 is arranged axially along an inner wall of the shell 110 for placing the first conductive sheet 206.

It can be understood that the electrical connection between the battery cell 201 and the second circuit board 205 is achieved by setting the first conductive sheet 206. This connection method not only ensures stable power supply, but also improves the reliability of the overall circuit. In addition, the arrangement of the positioning groove 115 provides necessary space for the precise installation of the first conductive sheet 206, ensuring its correct position in the battery pack structure. Accurate positioning of the first conductive sheet 206 in the positioning groove 115 can effectively prevent unnecessary movement or displacement of the first conductive sheet 206 after long-term use of the battery pack structure, which has a good effect on maintaining the usage performance and extending the service life of the battery pack structure.

Optionally, the first conductive sheet 206 can be a nickel sheet. In some embodiments, the first conductive sheet 206 includes a first connection portion 206a, a conductive sheet body 206b, and a second connection portion 206c. The first connection portion 206a and the second connection portion 206c are respectively connected to two ends of the conductive sheet body 206b. Optionally, the conductive sheet body 206b is a rectangular sheet-like structure. In order to make the conductive sheet more closely adhere to the side face of the battery cell 201, the conductive sheet can also be designed to have a curved surface structure. Optionally, the first connection portion 206a is a sheet-like structure, and the first connection portion 206a is electrically connected to an end of the battery cell 201 that is away from the control circuit board. In order to make the first connection portion 206a adhere to the end face of the battery cell 201, the first connection portion 206a is perpendicularly connected to the conductive sheet body 206b. Optionally, the second connection portion 206c is a sheet-like structure, and the second connection portion 206c is electrically connected to the second circuit board 205. In order to facilitate the connection between the second connection portion 206c and the second circuit board 205, they are arranged perpendicular to each other.

Further, two first positioning protrusions 204a are spaced apart on the outer periphery of the first circuit board 204, and a first slot is formed between the two first positioning protrusions 204a for placing the conductive sheet body 206b. By setting the first slot on the first circuit board 204, the conductive sheet body 206b can be limited, thereby making the overall battery cell integrated structure 200 more compact and stable. It can be understood that the distance between the two first positioning protrusions 204a is set according to the width of the conductive sheet body 206b, so as to ensure that the conductive sheet body 206b will not deviate, thereby ensuring the stability of the connection between the first conductive sheet 206 and the battery cell 201, as well as the stability, safety and reliability of the circuit.

Further, a first gasket 208 is provided at an end of the battery cell 201 that is away from the control circuit board, and a through hole is provided in the middle of the first gasket 208. The part of the first connection portion 206a that is away from the conductive sheet body 206b is bent in a direction toward the battery cell 201, so that a part of the structure of the first connection portion 206a can be located in the through hole of the first gasket 208. It can be understood that the first gasket 208 plays a positioning role for the first connection portion 206a, and at the same time, the arrangement of the first gasket 208 plays a buffering and protective role for the battery cell 201, reducing damage caused by collision or falling of the battery cell 201. Optionally, the first gasket 208 has a roughly circular shape, with an outer diameter thereof being equal to that of the battery cell 201. The through hole in the middle of the first gasket 208 is a rectangular through hole. Optionally, the material of the first gasket 208 can be rubber or foam, etc.

Further, the first connection portion 206a includes a first sheet-like structure 2061a and a second sheet-like structure 2062a. The first sheet-like structure 2061a is connected to the conductive sheet body 206b through the second sheet-like structure 2062a, and the second sheet-like structure 2062a and the conductive sheet body 206b are arranged perpendicular to each other. The first sheet-like structure 2061a and the second sheet-like structure 2062a are parallel to each other, and the first sheet-like structure 2061a is in contact with the battery cell 201. There is a certain gap between the second sheet-like structure 2062a and the battery cell 201, that is, there is a height difference between the second sheet-like structure 2062a and the first sheet-like structure 2061a. By setting the first connection portion 206a in this structural form, the first sheet-like structure 2061a can be placed in the through hole of the first gasket 208. Optionally, the height difference between the first sheet-like structure 2061a and the second sheet-like structure 2062a is equal to the thickness of the first gasket 208.

Further, a second conductive sheet 207 is provided at an end of the battery cell 201 that is close to the control circuit board. The battery cell 201 is electrically connected to the first circuit board 204 through the second conductive sheet 207. A second gasket 209 is arranged between the battery cell 201 and the first circuit board 204, and a through hole is provided in the middle of the second gasket 209. A part of the second conductive sheet 207 is bent in a direction toward the battery cell 201, so that a part of the structure of the second conductive sheet 207 can be located in the through hole of the second gasket 209. In order that the first conductive sheet 206 and the second gasket 209 can be assembled, the second conductive sheet 207 is provided with a third sheet-like structure 207a, a fourth sheet-like structure 207b, and a fifth sheet-like structure 207c. The third sheet-like structure 207a and the fifth sheet-like structure 207c are located at two ends of the fourth sheet-like structure 207b respectively, and there is a height difference between the third sheet-like structure 207a and the fourth sheet-like structure 207b. The fifth sheet-like structure 207c and the fourth sheet-like structure 207b are arranged perpendicular to each other, and the fifth sheet-like structure 207c extends in a direction toward the first circuit board 204. There is a height difference between the third sheet-like structure 207a and the fourth sheet-like structure 207b, so that the third sheet-like structure 207a can be placed in the through hole of the second gasket 209, thus achieving the contact between the third sheet-like structure 207a and the battery cell 201. Optionally, the height difference between the third sheet-like structure 207a and the fourth sheet-like structure 207b is equal to the thickness of the second gasket 209. By arranging the fifth sheet-like structure 207c and the fourth sheet-like structure 207b to be perpendicular to each other, the fifth sheet-like structure 207c can be connected to the first circuit board 204. Optionally, the second conductive sheet 207 can be a nickel sheet.

Further, two second positioning protrusions 209a are spaced apart on the outer periphery of the second gasket 209, and a second slot is formed between the two second positioning protrusions 209a for placing the conductive sheet body 206b, with the first slot and the second slot directly facing each other. By setting a second slot on the second gasket 209, the conductive sheet body 206b can be limited, thereby making the overall battery cell integrated structure 200 more compact and stable. It can be understood that the distance between the two second positioning protrusions 209a is set according to the width of the conductive sheet body 206b, so as to ensure that the conductive sheet body 206b will not deviate, thereby ensuring the stability of the connection between the first conductive sheet 206 and the battery cell 201, as well as the stability, safety and reliability of the circuit. For example, the through hole on the second gasket 209 is a rectangular through hole, and the material of the second gasket 209 can be rubber or foam, etc. Optionally, the outer periphery of the second gasket 209 is provided with a ring-like rib 209b, which is used to support the first circuit board 204.

Further, with continued reference to FIG. 4, a heat dissipation pad 215 is arranged on the outer periphery of the battery cell 201. By arranging the heat dissipation pad 215 on the outer periphery of the battery cell 201, accumulation of heat in the battery cell 201 can be reduced, preventing the temperature of the battery cell 201 from becoming too high, which would affect its usage performance and service life. At the same time, the arrangement of the heat dissipation pad 215 can reduce the impact of external collisions on the battery cell 201, avoiding damage to the battery cell 201 caused by collisions. Optionally, the heat dissipation pad 215 can be a rectangular pad like structure wound around the outer periphery of the battery cell 201, or a cylindrical structure sleeved onto the battery cell 201. Optionally, the heat dissipation pad 215 can be a thermal conductive silicone pad. Alternatively, when using a battery cell 201 with a larger outer diameter, there is no need to use the heat dissipation pad 215. Of course, the thickness of the heat dissipation pad 215 can also be adjusted according to the outer diameter size of the battery cell 201.

Referring to FIGS. 4-5, a switch button 213 is provided on the second circuit board 205. The switch button 213 is pressed to turn on the charging circuit, so that the power supply device can charge the battery pack structure. After the battery is fully charged, the button 213 is pressed again to disconnect the battery pack structure from the power supply device.

Further, indicator lights 214 are provided on the second circuit board 205. The design of the indicator lights 214 is to enable users to identify and know about the current status of the battery level more conveniently. Specifically, in this embodiment, the number of indicator lights 214 is set to two. In the case of complete depletion of the battery, neither of the indicator lights 214 will show any sign of lighting up, thus intuitively conveying to the user that the battery has been completely depleted. When users need to charge the device, they only need to connect the second connection end 203 to the corresponding power supply device. After the connection is completed, the user can press the button 213 to initiate the charging process. At this point, the first indicator light 214 will start lighting up in a way of flickering, indicating that charging is in progress and the battery level inside the battery pack structure is below 50%. As charging continues, once the battery level inside the battery pack structure exceeds 50%, the first indicator light 214 will transition to a state of continuously lighting up; at the same time, the second indicator light 214 will also start lighting up in a way of flickering, indicating that the battery level is further increasing. Finally, when the battery pack structure is fully charged, both indicator lights 214 will maintain a state of continuously lighting up, clearly indicating to the user that charging has been completed. Of course, in other embodiments, the number of indicator lights 214 can be three, four, or five, etc., which is specifically set based on the usage needs.

Optionally, a second connector 211 is provided at the second connection end 203, and a protective cover 212 is sleeved onto the second connector 211, with the protective cover 212 located above the button 213. The protective cover 212 provides protection for the second connection end 203. By pressing the protective cover 212, the button 213 is pressed. Optionally, the protective cover 212 is made of a transparent material, so that the position of the button 213 and the conditions of the indicator lights 214 can be observed. Optionally, the protective cover 212 can be made of a silicone material, which has a certain degree of elasticity, so that the button 213 can be pressed downward.

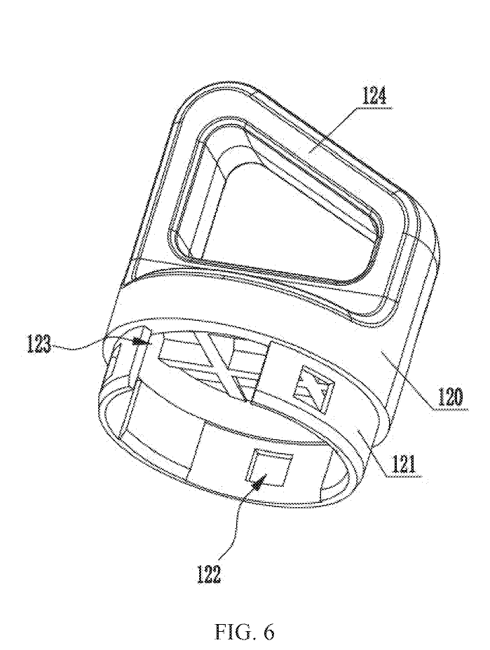

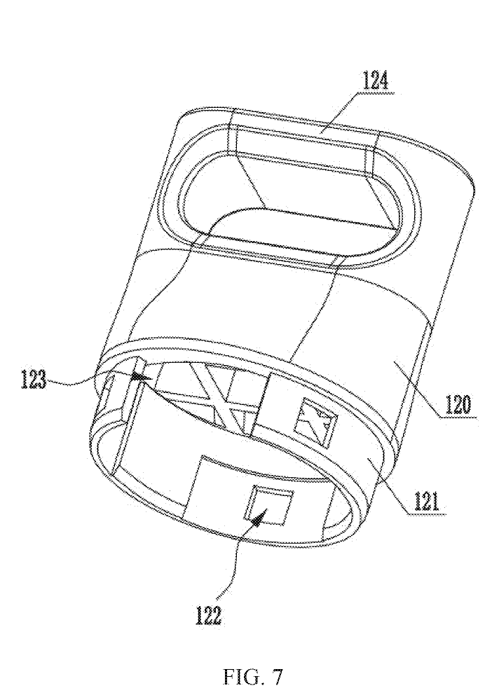

Further, FIG. 6 schematically shows a structural view of a cover 120 according to an embodiment of the present disclosure. FIG. 7 schematically shows a structural view of another cover 120 according to an embodiment of the present disclosure. Referring to FIGS. 5-7, the housing assembly 100 further includes a cover 120, and an insertion portion 121 is provided at an opening of the cover 120; the top of the shell 110 has an installation port, a snap-fit hole 122 is provided in a circumferential direction of the insertion portion 121, and a protrusion is arranged on an inner side of the top of the shell 110; the insertion portion 121 is inserted into the installation port, and the snap-fit hole 122 is snap-fit with the protrusion.

The quick installation of the cover 120 and the shell 110 can be achieved through the snap-fit connection between the snap-fit hole 122 and the protrusion. Optionally, the insertion portion 121 is a ring-like structure having a partial opening, and the arrangement of the opening gives the insertion portion 121 a certain degree of elasticity, making it easy for a buckle 114 to be snap-fit into the snap-fit hole 122; after the buckle 114 and the snap-fit hole 122 are matched, the insertion portion 121 can automatically rebound. Preferably, multiple buckles 114 are provided, and correspondingly, multiple snap-fit holes 122 are provided. By setting multiple buckles 114, the stability of connection can be increased. For example, the number of buckles 114 can be two, three, four, or five, etc., which can be specifically set based on the usage needs and which is not specifically limited herein. Preferably, a positioning protrusion 116 is provided inside the opening of the shell 110, and the opening on the insertion portion 121 is a positioning notch 123. When installing the cover 120, the positioning notch 123 is aligned directly with the positioning protrusion 116 to complete the insertion connection of the two. That is, the arrangement of the positioning notch 123 and the positioning protrusion 116 can facilitate the operator to determine the insertion position of the cover 120. In addition, after the cover 120 is inserted into the shell 110, the positioning protrusion 116 opens the positioning notch 123, causing the insertion portion 121 to expand tightly at the installation port of the shell 110, ensuring stable connection between the two and avoiding loosening or detachment.

Further, referring to FIGS. 6-7, a handle 124 is provided at the top of the cover 120, and a through hole is formed in the middle of the handle 124. The through hole can be used for an anti-slip rope to pass through. When taking out the battery pack structure, the anti-slip rope can be wrapped around the wrist to prevent the battery pack structure from slipping off the hand. Optionally, the shape of the handle can be set according to usage needs and is not specifically limited herein.

Further, this technical solution also provides an electric tool, which includes an electric tool body and the battery pack structure described above. The electric tool body has a battery compartment for installing the battery pack structure, and an inner wall of the battery compartment is provided with a connection port and a connection portion; the connection port is electrically connected to the first connection end 202, and the guide track 111 and the connection portion are slidably connected.

The electric tool body includes but is not limited to any of the following devices: grass cutter, blower, pruning machine, chainsaw, lawn mower, angle grinder, and electric drill. Of course, the electric tool body can also be other types of tools, which are not limited in the embodiments of the present application. The electric tool body receives electric power output from the battery pack structure through the connection port.

Described above are only specific preferred embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

What is claimed is:

1. A battery pack structure, comprising a housing assembly and a battery cell integrated structure; wherein the housing assembly comprises a shell, and a first avoidance port is provided at a bottom of the shell; the battery cell integrated structure is arranged inside the shell, and the battery cell integrated structure comprises a battery cell and a first connection end electrically connected to the battery cell; the first connection end is electrically connected to an electric tool body through the first avoidance port along an axial direction of the shell, so that the battery cell supplies power to the electric tool body; and an outer wall of the shell is provided with a guide track, wherein the outer wall of the shell is in contact with the electric tool body, and the guide track is slidably connected to the electric tool body, with a sliding direction being the axial direction of the shell.

2. The battery pack structure according to claim 1, wherein the guide track is a guide groove arranged axially along the outer wall of the shell.

3. The battery pack structure according to claim 2, wherein the guide groove comprises a first section and a second section; a first end of the first section has an insertion port facing the bottom of the shell; and a second end of the first section is communicated with the second section, and a width of the first section gradually decreases from the first end to the second end.

4. The battery pack structure according to claim 3, wherein the guide groove further comprises a third section communicated with the second section and a fourth section communicated with the third section, wherein the third section and the second section are arranged at an angle, and the fourth section is perpendicular to the third section.

5. The battery pack structure according to claim 1, wherein the guide track is a protrusion arranged axially along the outer wall of the shell, or the guide track is a magnetic attraction structure.

6. The battery pack structure according to claim 1, wherein the battery cell integrated structure further comprises a second connection end electrically connected to the battery cell, and a second avoidance port is provided at the bottom of the shell; the second connection end is electrically connected to a power supply device through the second avoidance port to supply power to the battery cell.

7. The battery pack structure according to claim 1, wherein the battery cell integrated structure further comprises a control circuit board located between the battery cell and the bottom of the shell; the control circuit board comprises a first circuit board and a second circuit board, wherein the first circuit board and the second circuit board are arranged along the axial direction of the shell, and the first circuit board is electrically connected to the second circuit board; and the first circuit board is located on a side adjacent to the battery cell, and the battery cell is electrically connected to the first connection end through the first circuit board.

8. The battery pack structure according to claim 7, wherein the battery cell integrated structure comprises a first conductive sheet, a first end of the first conductive sheet is electrically connected to an end of the battery cell, wherein the end of the battery cell is away from the first circuit board, and a second end of the first conductive sheet is electrically connected to the first circuit board; and a positioning groove is arranged axially along an inner wall of the shell for placing the first conductive sheet.

9. The battery pack structure according to claim 1, wherein the housing assembly further comprises a cover, and an insertion portion is provided at an opening of the cover; a top of the shell has an installation port, a snap-fit hole is provided in a circumferential direction of the insertion portion, and a protrusion is arranged on an inner side of the top of the shell; and the insertion portion is inserted into the installation port, and the snap-fit hole is snap-fit with the protrusion.

10. An electric tool, comprising the electric tool body and the battery pack structure according to claim 1; wherein the electric tool body has a battery compartment for installing the battery pack structure, and an inner wall of the battery compartment is provided with a connection port and a connection portion; and the connection port is electrically connected to the first connection end, and the guide track and the connection portion are slidably connected.
